(19) United States
(12) Patent Application Publication
(10) Pub. No.: US 2025/0031219 A1
(43) Pub. Date: Jan. 23, 2025

(54) METHOD AND APPARATUS FOR DELAYING SCHEDULING REQUEST IN WIRELESS COMMUNICATION SYSTEM

(71) Applicant: SAMSUNG ELECTRONICS CO., LTD., Suwon-si (KR)

(72) Inventors: Weiping SUN, Suwon-si (KR); Anil AGIWAL, Allen, TX (US); Jaehyuk JANG, Suwon-si (KR)

(21) Appl. No.: 18/776,087

(22) Filed: Jul. 17, 2024

Related U.S. Application Data
(60) Provisional application No. 63/514,516, filed on Jul. 19, 2023.

(51) Int. Cl. H04W 72/231; H04W 28/02; H04W 72/12

(52) U.S. Cl. CPC H04W 72/231; H04W 28/0278; H04W 72/12

(57) ABSTRACT

Provided is a fifth generation (5G) or sixth generation (6G) communication system for supporting higher data rates. A method includes receiving, from a base station, a radio resource control (RRC) message including a first parameter indicating whether to delay a scheduling request (SR) transmission; in case that a regular buffer status report (BSR) is triggered, identifying whether the first parameter indicates to delay the SR transmission; in case that the first parameter indicates to delay the SR transmission, identifying whether a timer used to determine whether to delay the SR transmission is running; and based on identifying whether the timer used to determine whether to delay the SR transmission is running, delaying the SR transmission or triggering the SR transmission.

### CROSS-REFERENCE TO RELATED APPLICATION

This application is based on and claims the benefit of U.S. Provisional Patent Application No. 63/514,516, filed on Jul. 19, 2023, in the United States Patent and Trademark Office.

### BACKGROUND

### 1. Field

The disclosure relates to a wireless communication system, and more particularly, to a method and apparatus for effectively delaying a scheduling request (SR) in a wireless communication system.

### 2. Description of the Related Art

Fifth generation (5G) mobile communication technologies define wide frequency bands to allow for high transmission rates and new services, and may also be implemented not only in a sub-6 Gigahertz (GHz) band, e.g., 3.5 GHz, but also in an ultrahigh frequency band (above 6 GHz) referred to as millimeter waves (mmWave) such as 28 GHz and 39 GHz. Moreover, for sixth generation (6G) mobile communication technologies referred to as a beyond 5G system, it is considered to be implemented in Terahertz (THz) bands (e.g., bands from 95 GHz to 3 THz) to attain transmission rates 50 times higher than an ultra-low delay reduced to one-tenth of the 5G mobile communication technology.

In an early stage of the 5G mobile communication technology, beamforming and massive multiple input multiple output (MIMO) to mitigate a radio path loss and increase the radio propagation distance in the ultra-high frequency band, support for various numerologies (operation of multiple subcarrier spacing) and dynamic slot format operation for efficient use of ultra-high frequency resources, initial access technologies for supporting multiple-beam transmission and widebands, definition and operation of bandwidth parts (BWPs), new channel coding schemes such as polar codes for highly reliable transmission of control information and low density parity check (LDPC) codes for high-volume data transmission, L2 preprocessing, network slicing for providing a dedicated network specialized for a particular service, etc., were standardized to support services and satisfy performance requirements for enhanced mobile broadband (eMBB), ultra-reliable low-latency communications (URLLC), and massive machine-type communications (mMTC).

Improvement and performance enhancement of the early 5G mobile communication technology are currently being discussed with consideration for the services that the 5G mobile communication technology has intended to support, and physical layer standardization for technologies such as vehicle-to-everything (V2X) to help driving decisions of autonomous vehicles and increase user convenience based on locations and status information of the vehicles transmitted by the vehicles, new radio unlicensed (NR-U) to aim at system operations conforming to various regulatory requirements in an unlicensed band, an NR terminal low-power consumption technology (UE power saving), non-terrestrial network (NTN), which is a direct terminal-satellite communication for securing coverage in a region where communication with a terrestrial network is unavailable, positioning, etc., is ongoing.

In addition, standardization of wireless interface architecture/protocol areas for technologies such as industrial Internet of things (IIoT) for supporting new services through connection and convergence with other industries, integrated access and backhaul (IAB) that provides a node to integrally support the wireless backhaul link and the access link to extend the network service area, mobility enhancement including conditional handover and dual active protocol stack (DAPS) handover, 2-step random access channel (RACH) for new radio (NR) to simplify the random access procedure, etc., and standardization of system architectures/service areas such as 5G baseline architectures (e.g., service based architectures or service based interfaces) for combination of network functions virtualization (NFV) and software-defined networking (SDN), mobile edge computing (MEC) to receive services based on a location of the terminal, etc., is also underway.

When such 5G mobile communication systems are commercialized, explosively increasing connected devices may be connected to the communication network, so that it is expected that enhancement of functions and performance of the 5G mobile communication system and integrated operation of the connected devices are required. For this, new research will be on the way for 5G performance enhancement and complexity reduction, artificial intelligence (AI) service support, metaverse service support, drone communication, etc., using AI, machine learning (ML) and extended reality (XR) to efficiently support augmented reality (AR), virtual reality (VR), mixed reality (MR), etc.

Advancement of the 5G mobile communication system may also be fundamental to developing not only a multiple antenna transmission technology such as large-scale antennas, array antennas, full dimensional multi-input multi-output (FD-MIMO) and new waveforms for guaranteeing coverage in THz bands of the 6G mobile communication technology, a high-dimensional spatial multiplexing technology using orbital angular momentum (OAM) and metamaterial based lens and antennas to enhance coverage of THz band signals, and a reconfigurable intelligent surface (RIS) technology, but also a full-duplex technology for frequency efficiency improvement and system network enhancement of the 6G mobile communication technology, an AI based communication technology to materialize system optimization by using a satellite and AI from a design stage and internalizing an end-to-end AI support function, a next generation distributed computing technology to materialize sophisticated services beyond the limit of terminal computation capacity by using ultra-high performance communication and computing resources, etc.

### SUMMARY

The disclosure may provide a method and apparatus for a user equipment (UE) to selectively apply scheduling request (SR) delay in a wireless communication system.

Additional aspects will be set forth in part in the description which follows and, in part, will be apparent from the description, or may be learned by practice of the presented embodiments of the disclosure.

According to an embodiment of the disclosure, a method performed by a terminal in a wireless communication system is provided. The method may comprise: receiving, from a base station, a radio resource control (RRC) message including a first parameter indicating whether to delay a scheduling request (SR) transmission; in case that a regular buffer status report (BSR) is triggered, identifying whether the first parameter indicates to delay the SR transmission; in case that the first parameter indicates to delay the SR transmission, identifying whether a timer used to determine whether to delay the SR transmission is running; and based on identifying whether the timer used to determine whether to delay the SR transmission is running, delaying the SR transmission or triggering the SR transmission.

According to an embodiment of the disclosure, a terminal in a wireless communication system is provided. The terminal may comprise: a transceiver; and at least one processor coupled with the transceiver and configured to: receive, from a base station via the transceiver, a radio resource control (RRC) message including a first parameter indicating whether to delay a scheduling request (SR) transmission; in case that a regular buffer status report (BSR) is triggered, identify whether the first parameter indicates to delay the SR transmission; in case that the first parameter indicates to delay the SR transmission, identify whether a timer used to determine whether to delay the SR transmission is running; and based on identifying whether the timer used to determine whether to delay the SR transmission is running, delay the SR transmission or triggering the SR transmission.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of a structure of an NR system according to an embodiment of the present disclosure;

FIG. 2 illustrates an example of a radio protocol architecture of an NR system according to an embodiment of the present disclosure;

FIG. 3 illustrates an example of an operation in which a BS configures configuration information of a user equipment (UE) through a radio resource control (RRC) message according to an embodiment of the present disclosure;

FIG. 4 illustrates an example of an operation of logicalChannelSessionTimer according to an embodiment of the present disclosure;

FIG. 5 illustrates an example of an operation in which a BS configures configuration information of a UE through an RRC message according to an embodiment of the present disclosure;

FIG. 6 illustrates an example of a UE according to an embodiment of the present disclosure; and

FIG. 7 illustrates an example of a BS according to an embodiment of the present disclosure.

### DETAILED DESCRIPTION

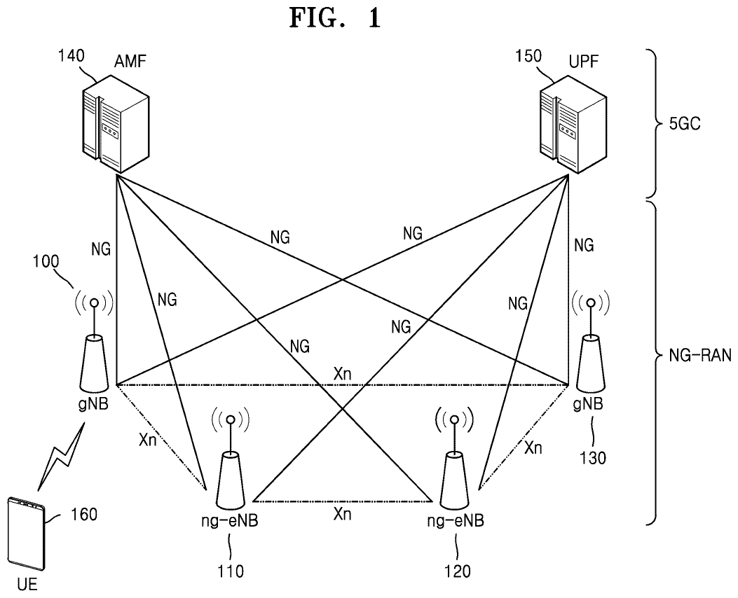

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the disclosure will now be described with reference to accompanying drawings. It is noted that in the drawings, like elements are denoted by like reference numerals. Detailed descriptions of functions and features known to the public, which might obscure the gist of the disclosure, will be omitted.

Technological content well-known in the art to which the disclosure pertains but not directly related to the disclosure will be omitted in the following description. Through the omission of the content that might otherwise obscure the subject matter of the disclosure, the subject matter will be understood more clearly.

For the same reason, some parts in the accompanying drawings are exaggerated, omitted or schematically illustrated. The size of the respective elements may not fully reflect their actual size. Like numbers refer to like elements throughout the drawings.

Advantages and features of the disclosure, and methods for attaining them will be understood more clearly with reference to the following embodiments of the disclosure, which will be described in detail below along with the accompanying drawings. The embodiments of the disclosure may, however, be embodied in many different forms and should not be construed as limited to the embodiments set forth herein; rather, these embodiments of the disclosure are provided so that this disclosure will be thorough and complete, and will fully convey the scope of the embodiments of the disclosure to those of ordinary skill in the art. Like numbers refer to like elements throughout the specification.

It may be understood that respective blocks and combinations of the blocks in processing flowcharts will be performed by computer program instructions. The computer program instructions may be loaded onto a processor of a universal computer, a special-purpose computer, or other programmable data processing equipment, and thus they generate means for performing functions described in the block(s) of the flowcharts when executed by the processor of the computer or other programmable data processing equipment. The computer program instructions may also be stored in computer-executable or computer-readable memory that may direct the computers or other programmable data processing apparatus to function in a particular manner, such that the instructions stored in the computer-executable or computer-readable memory may produce an article of manufacture including instruction means that perform the functions specified in the flowchart blocks(s). The computer program instructions may also be loaded onto the computer or other programmable data processing apparatus to cause a series of operational steps to be performed on the computer or other programmable apparatus to produce a computer implemented process such that the instructions that are executed on the computer or other programmable apparatus provide operations for implementing the functions specified in the flowchart block(s).

Furthermore, each block may represent a part of a module, segment, or code including one or more executable instructions to perform particular logic function(s). It is noted that the functions described in the blocks may occur out of order in some alternative embodiments. For example, two successive blocks may be performed substantially at the same time or in reverse order.

The term “module” (or sometimes “unit”) as used herein refers to a software or hardware component, such as field programmable gate array (FPGA) or application specific integrated circuit (ASIC), which performs some functions. However, the module is not limited to software or hardware. The module may be configured to be stored in an addressable storage medium, or to execute one or more processors. For example, the modules may include components, such as software components, object-oriented software components, class components and task components, processes, functions, attributes, procedures, subroutines, segments of program codes, drivers, firmware, microcodes, circuits, data, databases, data structures, tables, arrays, and variables. Functions served by components and modules may be combined into a small number of components and modules, or further divided into a larger number of components and modules. Moreover, the components and modules may be implemented to execute one or more central processing units (CPUs) in a device or security multimedia card.

In the following description, a base station (BS) is an entity for performing resource allocation for a terminal, and may be at least one of a Node B, eNode B (eNB), gNode B (gNB), a radio access unit, a base station controller, or a node on a network. A terminal may include a user equipment (UE), a mobile station (MS), a fifth generation (5G) UE, a cellular phone, a smart phone, a computer, or a multimedia system capable of performing communication functions. Furthermore, embodiments of the disclosure, which will now be described, may be equally applied to other communication systems with technical backgrounds or channel types similar to the embodiments of the disclosure. Furthermore, embodiments of the disclosure will also be applied to different communication systems with some modifications to such an extent that they do not significantly deviate from the scope of the disclosure when judged by those of ordinary skill in the art. For example, the 5th generation (5G) mobile communication technologies developed since the long term evolution (LTE) advanced (LTE-A), such as the 5G new radio (NR) may be included in the systems to which the embodiments of the disclosure will be applied, and the term “5G” as herein used may be a concept including the existing LTE, LTE-A, or other similar services. Furthermore, embodiments of the disclosure will also be applied to different communication systems with some modifications to such an extent that does not significantly deviate the scope of the disclosure when judged by skilled people in the art.

Herein, terms to identify access nodes, terms to refer to network entities or network functions (NFs), terms to refer to messages, terms to refer to interfaces between network entities, terms to refer to various types of identification information, etc., are examples for convenience of explanation. Accordingly, the disclosure is not limited to the terms as herein used, and may use different terms to refer to the items having the same meaning in a technological sense.

Hereinafter, for convenience of explanation, some of the terms and names defined by the 3rd generation partnership project (3GPP) LTE standard and/or a 3GPP NR standard may be used. The disclosure is not, however, limited to the terms and definitions, and may equally apply to any systems that conform to other standards.

FIG. 1 illustrates an example of a structure of an NR system according to an embodiment of the present disclosure;

Referring to FIG. 1, a wireless communication system may include several BSs (e.g., a gNB 100, ng-eNBs 110 and 120, and a gNB 130), an access and mobility management function (AMF) 140, a user plane function (UPF) 150, etc. It is obvious that the wireless communication system is not limited to what is shown in FIG. 1, but may include more or fewer components than in FIG. 1.

In an embodiment of the disclosure, a UE 160 may access an external network via the BSs 100, 110, 120 and 130 and the UPF 150.

In FIG. 1, the BSs 100, 110, 120 and 130 are access nodes in cellular networks to enable UEs to wirelessly access the cellular networks. For example, the BSs 100, 110, 120 and 130 may collect status information such as buffer status, available transmission power status, channel conditions, etc., of the UEs 160 to serve traffic for the users, and make scheduling based on the collected information to support connection between UEs and a core network (CN), where a CN of NR in particular is referred to as a 5GC.

In FIG. 1, gNBs 100 and 130 may control a plurality of cells, and may use an adaptive modulation and coding (AMC) scheme that determines a modulation scheme and a channel coding rate according to the channel condition of the UE 160.

The CN is a device responsible for various control functions as well as a mobility management function for the UE, and may be connected to the plurality of BSs 100, 110, 120 and 130. Furthermore, the 5GC may also be connected to the existing LTE system.

In the meantime, in the wireless communication system, a user plane (UP) related to actual user data transmission and a control plane (CP) for connection management or the like may be separately configured. The gNB 100 and the gNB 130 of FIG. 1 may use UP and CP technologies defined in the NR technology, and the ng-eNB 110 and the ng-eNB 120 may use UP and CP technologies defined in the LTE technology although connected to the 5GC.

The AMF 140 is a device responsible for various control functions as well as a mobility management function for the UE 160, and may be connected to the plurality of BSs 100, 110, 120 and 130.

The UPF 150 may refer to a kind of gateway device that provides data transmission. Although not shown in FIG. 1, the NR wireless communication system may also include a session management function (SMF). The SMF may manage packet data network connection such as a protocol data unit (PDU) session provided for the UE 160.

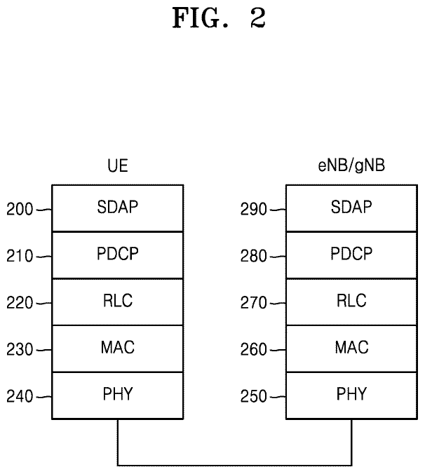

FIG. 2 illustrates an example of a radio protocol architecture of an NR system according to an embodiment of the present disclosure.

Referring to FIG. 2, a radio protocol of the NR system may include a service data adaptation protocol (SDAP) layer 200 or 290, a packet data convergent protocol (PDCP) layer 210 or 280, a radio link control (RLC) layer 220 or 270, a medium access control (MAC) layer 230 or 260 or physical (PHY) layer 240 or 250 in each of the UE and the BS.

The SDAP layer 200 or 290 may deliver user data, and perform an operation of mapping a quality of service (QOS) flow to a particular data radio bearer (DRB) for uplink (UL) and downlink (DL), an operation of marking a QoS flow identifier (ID) for UL and DL, and an operation of mapping a reflective QoS flow to a data bearer for UL SDAP PDUs. An SDAP configuration corresponding to each DRB may be provided from a higher RRC layer. It is, of course, not limited thereto.

The PDCP layer 210 or 280 may be responsible for operations such as Internet protocol (IP) header compression/decompression, etc. The PDCP layer 210 or 280 may also provide a sequential or non-sequential delivery functions, reorder the sequence, and provide duplicate detection, retransmission, cyphering and deciphering functions. It is, of course, not limited thereto.

The RLC layer 220 or 270 may reconfigure a PDCP protocol data unit (PDU) into a suitable size. Furthermore, the RLC layer 220 or 270 may provide a sequential or non-sequential delivery function, and provide an automatic repeat request (ARQ) function, splicing, division and reassembling functions, a sequence reordering function, a duplicate detection function, and an error detection function. It is, of course, not limited thereto.

The MAC layer 230 or 260 may be connected to a number of RLC layer devices configured in one UE, and may perform operations of multiplexing RLC PDUs to a MAC PDU and demultiplexing RLC PDUs from a MAC PDU. Furthermore, the MAC layer 230 or 260 may provide a mapping function, a scheduling information report function, a hybrid ARQ (HARQ) function, a function of controlling priority between logical channels, a function of controlling priority between UEs, a multimedia broadcast multicast service (MBMS) service check function, a transfer format selection function, and a padding function. It is, of course, not limited thereto.

The PHY layer 240 or 250 may perform channel coding and modulation on higher layer data, form the data into orthogonal frequency division multiplexing (OFDM) symbols and transmit them on a radio channel, or may demodulate OFDM symbols received on a radio channel, perform channel decoding on them and send the result to a higher layer. Furthermore, even the PHY layer uses an HARQ for additional error correction, and a receiving end may transmit whether a packet has been received from a transmitting end in one bit. The one bit information is referred to as HARQ acknowledgment (ACK)/negative ACK (NACK) information.

DL HARQ ACK/NACK information for UL data transmission is sent on a physical HARQ indicator channel (PHICH) for the LTE, and whether retransmission or new transmission is required may be determined based on scheduling information for the UE on a physical dedicated control channel (PDCCH), on which DL/UL resource allocations are transmitted for the NR. This is because NR employs an asynchronous HARQ. UL HARQ ACK/NACK information for DL data transmission may be transmitted on a physical uplink control channel (PUCCH) or a physical uplink shared channel (PUSCH) physical channel. The PUCCH is commonly transmitted in a UL of a primary cell (Pcell) as will be described below, but sometimes additionally transmitted to the UE in a secondary cell (Scell) as will be described below, which is referred to as a PUCCH Scell.

Although not shown in FIG. 2, there are radio resource control (RRC) layers above the PDCP layers of the UE and the BS, and the RRC layers may exchange control messages related to access and measurement for radio resource control.

The PHY layer may be configured with multiple frequencies/carriers, and a technology that allocates and uses multiple frequencies simultaneously may be referred to as carrier aggregation (CA). Unlike a single carrier being used for communication between UE and BS (eNB or gNB), CA technology may use a main carrier and one or multiple additional subcarriers, thereby dramatically increasing the amount of transmission by the number of the subcarriers. In the meantime, a cell of the BS that uses the main carrier is referred to as a main cell or a primary cell (Pcell) and a cell of the BS that uses the subcarrier is referred to as a sub-cell or a Scell in LTE/NR.

The UE may trigger a buffer status report (BSR) in a corresponding cell group when one of the following conditions is met:
condition 1-1: New UL data occurs in a logical channel (LCH) that belongs to a logical channel group (LCG), and in this case, the priority of the LCH is higher than other LCHs having UL data. In this case, the triggered regular BSR may be regarded as being triggered by the LCH in which the new UL data occurs;
condition 1-2: New UL data occurs in an LCH that belongs to an LCG, and no UL data was present in all LCHs that belong to all LCGs before the new UL data occurs. In this case, the triggered regular BSR may be regarded as being triggered by the LCH in which the new UL data occurs; and
condition 1-3: UL data is in at least one LCH at the expiry of retxBSR-Timer, and the LCH belongs to the LCG. In this case, the triggered regular BSR may be regarded as being triggered by an LCH having the highest priority among LCHs in which the UL data is present.

In a case that the regular BSR is triggered and logicalChannelSR-DelayTimerApplied of the LCH that triggers the regular BSR is set to true, the UE may start/restart logicalChannelSR-DelayTimer of the LCH. The logicalChannelSR-DelayTimerApplied may be a parameter that indicates whether to apply a delay timer for SR transmission for the LCH, and the delay timer may include the logicalChannelSR-DelayTimer.

In a case that the regular BSR is triggered and the logicalChannelSR-DelayTimerApplied of the LCH that triggers the regular BSR is set to false, the UE may stop the timer when the logicalChannelSR-DelayTimer of the LCH is running.

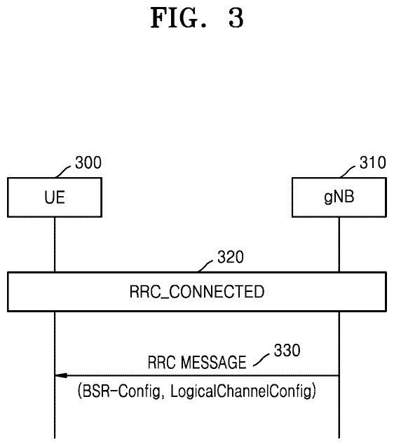

FIG. 3 illustrates an example of a procedure in which a BS configures UE configuration information through an RRC message according to an embodiment of the present disclosure.

Referring to FIG. 3, a BS 310 may transmit an RRC message 330 to a UE 300 in an RRC_connected state 320. The RRC message may be an RRC reconfiguration message. The RRC message may be an RRC setup message. The RRC message may be an RRC resume message. The RRC message may include a BSR-config information element (IE). The RRC message may include a LogicalChannelConfig IE. The BSR-config IE may be present/set for each cell group. The LogicalChannelConfig IE may be present/set for each LCH. logicalChannelSR-DelayTimerApplied of a certain LCH may be set in a corresponding field of the logicalChannelConfig IE of the LCH. The size of the logicalChannelSR-Delay Timer to be applied in a certain cell group may be set in a corresponding field of the BSR-Config IE of the cell group.

When the logicalChannelSR-DelayTimer of an LCH that triggers a regular BSR is not running when the regular BSR has already been triggered, the UE may trigger a scheduling request (SR) corresponding to the LCH that triggers the regular BSR when one of the following conditions is met:
condition 2-1: there is no UL shared channel (UL_SCH) resource for new transmission;
condition 2-2: configured grant(s) is configured for a corresponding MAC entity, and the LCH that triggers the regular BSR has logicalChannelSR-Mask set to false; or
condition 2-3: there is a UL-SCH resource for new transmission, but the UL-SCH resource is unavailable for the LCH that triggers the regular BSR due to logical channel prioritization (LCP) mapping restriction.

The logicalChannelSR-Mask may be a parameter to control SR triggering when the configured grant is set.

The logicalChannelSR-DelayTimer may be used for a purpose of delaying the SR triggering while the timer is running without triggering the SR right after the regular BSR is triggered. The reason to delay the SR triggering is that for an application having periodic characteristics like a voice over Internet protocol (VoIP), instead of sending an SR each time a packet is generated, the BS is able to allocate a UL resource without an SR of the UE because the BS is able to know when UL data may occur by taking into account traffic characteristics of the application when the BS knows the traffic characteristics beforehand. When the UL resource is allocated while the SR transmission is delayed, the triggered SR may be canceled, thereby saving PUCCH resources used for SR transmission.

However, the BS is unable to know when the application may be started or when the first packet of the application may occur in UL until the UE sends an SR. In a case that the SR delay is applied even for the first packet that indicates the start of the application when the first packet occurs, the BS may not allocate the UL resource because it may not know that the application has already been started while the SR is being delayed, and accordingly, the application service may be delayed as well.

The disclosure provides a scheme capable of triggering an SR right away without applying the SR delay for the first packet that usually occurs in the beginning of a service of a certain application. Accordingly, the BS is able to know the beginning of the service more quickly, thereby further enhancing the service quality.

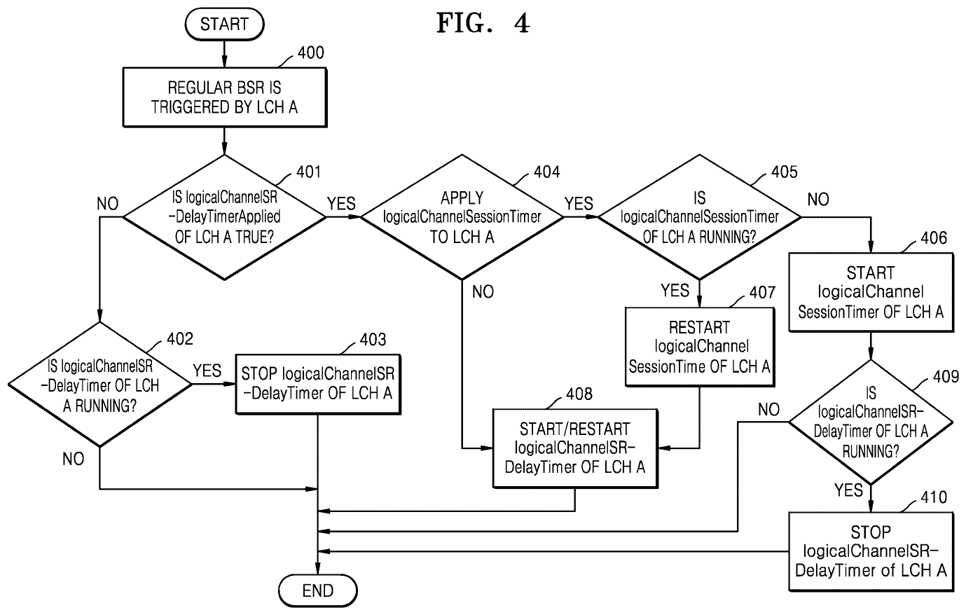

FIG. 4 illustrates an example in which a UE selectively applies SR delay according to an embodiment of the disclosure.

Referring to FIG. 4, the BS may introduce a new timer for the UE in order to determine whether to apply the SR delay. For example, in the disclosure, the new timer may be referred to as logicalChannelSessionTimer. For example, when the regular BSR is triggered while the logicalChannelSessionTimer is running, the UE may start/restart logicalChannelSR-DelayTimer to delay SR triggering until the logicalChannelSR-DelayTimer is expired.

For example, when the regular BSR is triggered while the logicalChannelSessionTimer is not running, a corresponding SR may be triggered right away regardless of the status of the logicalChannelSR-DelayTimer. For example, when the regular BSR is triggered while the logicalChannelSessionTimer is not running, and the logicalChannelSR-DelayTimer is running, the logicalChannelSR-DelayTimer may be stopped.

For example, the BS may configure whether the UE is to apply the logicalChannelSessionTimer, in an RRC message for each LCH. For example, whether the UE is to apply the logicalChannelSessionTimer may be configured in a particular filed of the RRC message, e.g., a logicalChannelSessionTimerApplied field, such that the timer is applied when the field is set to true and not applied when the field is set to false.

For example, the logicalChannelSessionTimer may run for each LCH of the UE. For example, the logicalChannelSessionTimer may run for each cell group of the UE, each DRB, each LCG or each UE. The size of the logicalChannelSessionTimer may be set for each cell group, each DRB, each LCG, each LCH or each UE. The logicalChannelSessionTimerApplied may be set for each cell group of the UE, each DRB, each LCG, each LCH or each UE. For example, the logicalChannelSession TimerApplied may not be set for a particular cell group/DRB/LCG/LCH/UE, which may be handled in the same sense as when the field is set to false.

For example, the logicalChannelSessionTimerApplied may not be set for a particular cell group/DRB/LCG/LCH/UE, which may be handled in the same sense as when the field is set to true. For example, when the size of the timer is set in the logicalChannelSessionTimer field for a particular cell grpu/DRB/LCG/LCH/UE, the logicalChannelSessionTimer may be applied for the cell group/DRB/LCG/LCH/UE regardless of whether there is the logicalChannelSessionTimerApplied field or of setting values.

For example, the size of the logicalChannelSessionTimer may be set by taking into account traffic characteristics of a particular LCH to which the timer is to be applied. For example, the BS may map a particular QoS flow to a particular DRB, map the DRB to an LCH, and set a size of the logicalChannelSessionTimer of the LCH with consideration for traffic characteristics (e.g., inter session time) of the mapped QoS flow.

Referring to FIG. 4, when a regular BSR is triggered by a particular LCH (referred to as LCH A) of the UE in operation 400, the UE may operate as follows:
identify whether the logicalChannelSR-DelayTimerApplied of LCH A is true in operation 401. In a case that the logicalChannelSR-DelayTimerApplied is true:
determine whether to apply the logicalChannelSessionTimer for LCH A in operation 404. In a case of applying the logicalChannelSessionTimer for LCH A,
when the logicalChannelSessionTimer of LCH A is running,
restart the logicalChannelSessionTimer of LCH A in operation 407, and
start or restart the logicalChannelSR-DelayTimer of LCH A in operation 408,
when the logicalChannelSessionTimer of LCH A is not running,
start the logicalChannelSessionTimer of LCH A in operation 406, and
when the logicalChannelSR-DelayTimer of LCH A is running,
stop the logicalChannelSR-DelayTimer of LCH A in operation 410,
when the logicalChannelSessionTimer of LCH A is not applied,
start or restart the logicalChannelSR-DelayTimer in operation 408; and
in a case that the logicalChannelSR-DelayTimerApplied of LCH A is false,
when the logicalChannelSR-DelayTimer of LCH A is running,
stop the logicalChannelSR-DelayTimer in operation 403.

Specifically, the UE may trigger a regular BSR for LCH A in operation 400.

In operation 401, the UE may determine whether a value of a parameter that indicates whether to apply a delay timer for SR transmission, i.e., logicalChannelSR-DelayTimerApplied, is true.

When the value of the logicalChannelSR-DelayTimerApplied is not true in operation 401, the UE may determine whether a delay timer of LCH A, i.e., logicalChannelSR-DelayTimer, is running in operation 402.

When the logicalChannelSR-DelayTimer is running in operation 402, the UE may stop the logicalChannelSR-DelayTimer in operation 403. For example, the UE may stop the logicalChannelSR-DelayTimer and perform SR transmission.

When the logicalChannelSR-DelayTimer is not running in 402, the UE may perform SR transmission.

When the value of the logicalChannelSR-DelayTimerApplied is true in operation 401, the UE may determine whether to apply a timer associated with applying of SR delay for LCH A, i.e., the logicalChannelSessionTimer, in operation 404. For example, the UE may determine whether to apply the logicalChannelSessionTimer for LCH A based on an RRC message indicating whether to apply the logicalChannelSessionTimer, as described above.

When the logicalChannelSessionTimer is not applied for LCH A in operation 404, the UE may start or restart the logicalChannelSR-DelayTimer of LCH A in operation 408. For example, the UE may start or restart the logicalChannelSR-DelayTimer and delay the SR transmission for LCH A.

When the logicalChannelSessionTimer is applied for LCH A in operation 404, the UE may determine whether the logicalChannelSessionTimer of LCH A is running in operation 405.

When the logicalChannelSession Timer is running in operation 405, the UE may restart the logicalChannelSessionTimer in operation 407, and start or restart the logicalChannelSR-DelayTimer of LCH A in operation 408. For example, the UE may start or restart the logicalChannelSR-DelayTimer and delay the SR transmission for LCH A.

When the logicalChannelSessionTimer is not running in operation 405, the UE may start the logicalChannelSessionTimer in operation 406, and determine whether the logicalChannelSR-DelayTimer of LCH A is running in operation 409.

When the logicalChannelSR-DelayTimer is running in operation 409, the UE may stop the logicalChannelSR-DelayTimer of LCH A in operation 410. For example, the UE may stop the logicalChannelSR-DelayTimer and perform SR transmission.

When the logicalChannelSR-DelayTimer is not running in 409, the UE may perform SR transmission.

In an embodiment of the disclosure, when the logicalChannelSession Timer is not running, the UE may determine that an LCH for which the regular BSR is triggered is associated with the first packet that occurs in the beginning of a service of the application. The UE may not apply SR delay when the logicalChannelSessionTimer is not running, thereby triggering the SR right away without applying the SR delay for the first packet that occurs in the beginning of the service of the application.

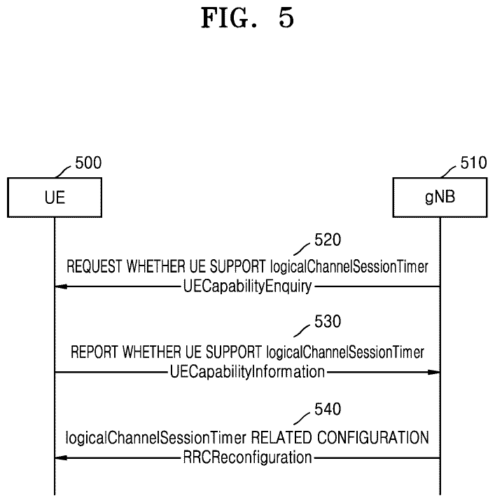

FIG. 5 illustrates an example of a procedure in which a BS and a UE determine whether the UE supports the logicalChannelSessionTimer, through RRC signaling, and configure logicalChannelSessionTimer related configuration. In other words, shown is a signaling procedure performed by the UE and the BS to use the logicalChannelSessionTimer.

Referring to FIG. 5, in operation 520, the BS may send a UE capability request (UECapabilityEnquiry) message requesting the UE in an RRC_connected state to report the UE's capability. The BS may add a UE capability request for each radio access technology type to the UECapabilityEnquiry message. The UE capability request for each RAT type may include required frequency band information.

Furthermore, the BS may add filtering information indicating terms and restrictions to the UECapabilityEnquiry message when requesting the UE to generate a UECapabilityInformation message. In this case, the BS may indicate whether the UE is to report whether the UE supports the logicalChannelSessionTimer, through the filtering information.

In operation 530, the UE may configure a UE capability information (UECapabilityInformation) message corresponding to the UECapabilityEnquiry message and send the BS the response to the UECapabilityEnquiry message. In this case, the UECapabilityInformation message may include a parameter indicating whether the UE supports the logicalChannelSessionTimer.

For example, the parameter may be 1-bit information. Furthermore, when the parameter is included, it may indicate that the logicalChannelSessionTimer is supported, and when the parameter is not included, it may indicate that the logicalChannelSessionTimer is not supported. The BS may determine based on the received UECapabilityInformation message whether the UE supports the logicalChannelSessionTimer.

When the BS determines that the UE supports the logicalChannelSessionTimer, the BS may indicate the logicalChannelSessionTimer related configuration by adding the timer to the RRCReconfiguration message, in operation 540. The UE may apply the logicalChannelSessionTimer related configuration information included in the received RRCReconfiguration message.

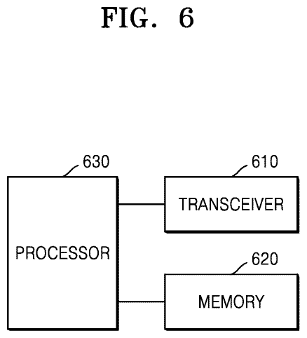

FIG. 6 illustrates an example of a UE according to an embodiment of the present disclosure.

Referring to FIG. 6, the UE in the disclosure may include a transceiver 610, a memory 620, and a processor 630. The transceiver 610, the memory 620, and the processor 630 of the UE may operate according to the aforementioned communication method of the UE. Components of the UE are not, however, limited thereto. For example, the UE may include more or fewer elements than described above. In addition, the processor 630, the transceiver 610 and the memory 620 may be implemented in the form of a single chip.

The transceiver 610 is a collective term of a UE transmitter and a UE receiver, and may transmit or receive a signal to or from a network entity. The signal to be transmitted to or received from the BS may include control information and data. For this, the transceiver 610 may include an RF transmitter for up-converting the frequency of a signal to be transmitted and amplifying the signal and an RF receiver for low-noise amplifying a received signal and down-converting the frequency of the received signal. It is merely an embodiment of the transceiver 610, and the elements of the transceiver 610 are not limited to the RF transmitter and RF receiver.

The transceiver 610 may include a wired/wireless transceiver, including various components for signal transmission and reception.

In addition, the transceiver 610 may receive a signal on a wired or wireless channel and output the signal to the processor 630, or transmit a signal output from the processor 630 on a wired or wireless channel.

The transceiver 610 may receive a communication signal and output the communication signal to the processor 630, and transmit a signal output from the processor 630 to a network entity over a wired or wireless network.

The memory 620 may store a program and data required for operation of the UE. Furthermore, the memory 620 may store control information or data included in a signal obtained by the UE. The memory 620 may include a storage medium such as a read only memory (ROM), a random access memory (RAM), a hard disk, a compact disc ROM (CD-ROM), and a digital versatile disk (DVD), or a combination of storage mediums.

The processor 630 may control a series of processes for the UE to be operated according to the embodiments of the disclosure. The processor 630 may include at least one processor. For example, the processor 630 may include a communication processor (CP) for controlling communication and an application processor (AP) for controlling a higher layer such as an application program.

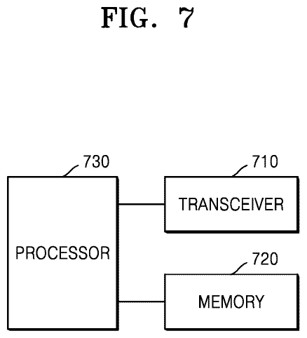

FIG. 7 illustrates an example of a BS according to an embodiment of the present disclosure.

Referring to FIG. 7, the BS in the disclosure may include a transceiver 710, a memory 720, and a processor 730. The transceiver 710, the memory 720, and the processor 730 of the BS may operate according to the aforementioned communication method of the BS. Components of the BS are not, however, limited thereto. For example, the BS may include more or fewer components than described above. In addition, the processor 730, the transceiver 710 and the memory 720 may be implemented in the form of a single chip.

The transceiver 710 is a collective term of a BS receiver and a BS transmitter, and may transmit or receive a signal to or from a UE or another BS. The signal to be transmitted to or received may include control information and data. For this, the transceiver 710 may include an RF transmitter for up-converting the frequency of a signal to be transmitted and amplifying the signal and an RF receiver for low-noise amplifying a received signal and down-converting the frequency of the received signal. It is merely an example of the transceiver 710, and the elements of the transceiver 710 are not limited to the RF transmitter and RF receiver. The transceiver 710 may include a wired/wireless transceiver, including various components for signal transmission and reception.

In addition, the transceiver 710 may receive a signal on a communication channel (e.g., a wireless channel) and output the signal to the processor 730, or transmit a signal output from the processor 730 on the communication channel.

The transceiver 710 may receive a communication signal and output the communication signal to the processor 730, and transmit a signal output from the processor 730 to a UE or a network entity over a wired or wireless network.

The memory 720 may store a program and data required for an operation of the BS. Furthermore, the memory 720 may store control information or data included in a signal obtained by the BS. The memory 720 may include a storage medium such as a ROM, a RAM, a hard disk, a CD-ROM, and a DVD, or a combination of storage mediums.

The processor 730 may control a series of processes for the BS to be operated according to the embodiments of the disclosure. The processor 730 may include at least one processor. Methods according to the claims of the disclosure or the embodiments of the disclosure described in the specification may be implemented in hardware, software, or a combination of hardware and software.

In accordance with an embodiment of the disclosure, a method performed by a terminal in a wireless communication system is provided. The method may comprise: receiving, from a base station, a radio resource control (RRC) message including a first parameter indicating whether to delay a scheduling request (SR) transmission; in case that a regular buffer status report (BSR) is triggered, identifying whether the first parameter indicates to delay the SR transmission; in case that the first parameter indicates to delay the SR transmission, identifying whether a timer used to determine whether to delay the SR transmission is running; and based on identifying whether the timer used to determine whether to delay the SR transmission is running, delaying the SR transmission or triggering the SR transmission.

In an embodiment, the RRC message further includes a second parameter indicating whether to apply a delay timer for the SR transmission.

In an embodiment, wherein the identifying whether the first parameter indicates to delay the SR transmission comprises: in case that the regular BSR is triggered and that the second parameter indicates to apply the delay timer for the SR transmission, identifying whether the first parameter indicates to delay the SR transmission.

In an embodiment, wherein the delaying of the SR transmission comprises: in case that the timer used to determine whether to delay the SR transmission is running, delaying the SR transmission.

In an embodiment, the method may further comprise: in case that the timer used to determine whether to delay the SR transmission is running, starting or restarting a delay timer for the SR transmission, wherein the SR transmission is delayed until the delay timer for the SR transmission expires.

In an embodiment, the method may further comprise in case that the timer used to determine whether to delay the SR transmission is running, restarting the timer used to determine whether to delay the SR transmission.

In an embodiment, wherein the triggering of the SR transmission comprises: in case that the timer used to determine whether to delay the SR transmission is not running, triggering the SR transmission.

In an embodiment, the method may further comprise: in case that the timer used to determine whether to delay the SR transmission is not running, starting the timer used to determine whether to delay the SR transmission.

In an embodiment, the method may further comprise: identifying whether a delay timer for the SR transmission is running; and in case that the delay timer for the SR transmission is running, stopping the delay timer for the SR transmission.

In an embodiment, the method may further comprise: in case that the regular BSR is triggered and that the second parameter indicates not to apply the delay timer for the SR transmission, identifying whether the delay timer for the SR transmission is running; and in case that the delay timer for the SR transmission is running, stopping the delay timer for the SR transmission.

In accordance with an embodiment of the disclosure, a terminal in a wireless communication system is provided. The terminal may comprise: a transceiver; and at least one processor coupled with the transceiver and configured to: receive, from a base station via the transceiver, a radio resource control (RRC) message including a first parameter indicating whether to delay a scheduling request (SR) transmission; in case that a regular buffer status report (BSR) is triggered, identify whether the first parameter indicates to delay the SR transmission; in case that the first parameter indicates to delay the SR transmission, identify whether a timer used to determine whether to delay the SR transmission is running; and based on identifying whether the timer used to determine whether to delay the SR transmission is running, delay the SR transmission or triggering the SR transmission.

In an embodiment, wherein the RRC message further includes a second parameter indicating whether to apply a delay timer for the SR transmission.

In an embodiment, wherein the at least one processor is further configured to: in case that the regular BSR is triggered and that the second parameter indicates to apply the delay timer for the SR transmission, identify whether the first parameter indicates to delay the SR transmission.

In an embodiment, wherein the at least one processor is further configured to: in case that the timer used to determine whether to delay the SR transmission is running, delay the SR transmission.

In an embodiment, wherein the at least one processor is further configured to: in case that the timer used to determine whether to delay the SR transmission is running, start or restart a delay timer for the SR transmission, wherein the SR transmission is delayed until the delay timer for the SR transmission expires.

Methods according to the claims of the disclosure or the embodiments of the disclosure described in the specification may be implemented in hardware, software, or a combination of hardware and software.

When implemented in software, a computer-readable storage medium storing one or more programs (software modules) may be provided. The one or more programs stored in the computer-readable storage medium are configured for execution by one or more processors in an electronic device. The one or more programs may include instructions that cause the electronic device to perform the methods in accordance with the claims of the disclosure or the embodiments described in the specification.

The programs (software modules, software) may be stored in a random access memory (RAM), a non-volatile memory including a flash memory, a read only memory (ROM), an electrically erasable programmable ROM (EEPROM), a magnetic disc storage device, a compact disc-ROM (CD-ROM), a digital versatile disc (DVD) or other types of optical storage device, and/or a magnetic cassette. Alternatively, the programs may be stored in a memory including a combination of some or all of them. There may be a plurality of memories.

The program may also be stored in an attachable storage device that may be accessed over a communication network including the Internet, an intranet, a local area network (LAN), a wide LAN (WLAN), or a storage area network (SAN), or a combination thereof. The storage device may be connected to an apparatus performing the embodiments of the disclosure through an external port. In addition, a separate storage device in the communication network may be connected to the apparatus performing the embodiments of the disclosure.

In the embodiments of the disclosure, a component is represented in a singular or plural form. It should be understood, however, that the singular or plural representations are selected appropriately according to the situations presented for convenience of explanation, and the disclosure is not limited to the singular or plural form of the component. Further, the component expressed in the plural form may also imply the singular form, and vice versa.

Several embodiments of the disclosure have thus been described, but it will be understood that various modifications can be made without departing the scope of the disclosure. Thus, it will be apparent to those ordinary of skill in the art that the disclosure is not limited to the embodiments described, but can encompass not only the appended claims but the equivalents. Thus, it will be apparent to those ordinary of skill in the art that the disclosure is not limited to the embodiments of the disclosure described, which have been provided only for illustrative purposes. Furthermore, the embodiments may be operated by being combined with one another if necessary. For example, parts of the methods provided in the disclosure may be combined to operate the BS and the UE. Although the embodiments of the disclosure are provided based on 5G or NR systems, modifications to the embodiments of the disclosure, which do not deviate from the scope of the disclosure, may be applicable to other systems such as an LTE system, an LTE-A system, an LTE-A-Pro system, etc.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
receiving, from a base station, a radio resource control (RRC) message including a first parameter indicating whether to delay a scheduling request (SR) transmission;
in case that a regular buffer status report (BSR) is triggered, identifying whether the first parameter indicates to delay the SR transmission;
in case that the first parameter indicates to delay the SR transmission, identifying whether a timer used to determine whether to delay the SR transmission is running; and
based on identifying whether the timer used to determine whether to delay the SR transmission is running, delaying the SR transmission or triggering the SR transmission.

2. The method of claim 1, wherein the RRC message further includes a second parameter indicating whether to apply a delay timer for the SR transmission.

3. The method of claim 2, wherein identifying whether the first parameter indicates to delay the SR transmission comprises:
in case that the regular BSR is triggered and that the second parameter indicates to apply the delay timer for the SR transmission, identifying whether the first parameter indicates to delay the SR transmission.

4. The method of claim 1, wherein delaying the SR transmission comprises:
in case that the timer used to determine whether to delay the SR transmission is running, delaying the SR transmission.

5. The method of claim 4, further comprising:
in case that the timer used to determine whether to delay the SR transmission is running, starting or restarting a delay timer for the SR transmission,
wherein the SR transmission is delayed until the delay timer for the SR transmission expires.

6. The method of claim 4, further comprising:
in case that the timer used to determine whether to delay the SR transmission is running, restarting the timer used to determine whether to delay the SR transmission.

7. The method of claim 1, wherein triggering the SR transmission comprises:
in case that the timer used to determine whether to delay the SR transmission is not running, triggering the SR transmission.

8. The method of claim 7, further comprising:
in case that the timer used to determine whether to delay the SR transmission is not running, starting the timer used to determine whether to delay the SR transmission.

9. The method of claim 7, further comprising:
identifying whether a delay timer for the SR transmission is running; and
in case that the delay timer for the SR transmission is running, stopping the delay timer for the SR transmission.

10. The method of claim 2, further comprising:
in case that the regular BSR is triggered and that the second parameter indicates not to apply the delay timer for the SR transmission, identifying whether the delay timer for the SR transmission is running; and
in case that the delay timer for the SR transmission is running, stopping the delay timer for the SR transmission.

11. A terminal in a wireless communication system, the terminal comprising:
a transceiver; and
at least one processor coupled with the transceiver and configured to:
receive, from a base station via the transceiver, a radio resource control (RRC) message including a first parameter indicating whether to delay a scheduling request (SR) transmission;
in case that a regular buffer status report (BSR) is triggered, identify whether the first parameter indicates to delay the SR transmission;
in case that the first parameter indicates to delay the SR transmission, identify whether a timer used to determine whether to delay the SR transmission is running; and
based on identifying whether the timer used to determine whether to delay the SR transmission is running, delay the SR transmission or trigger the SR transmission.

12. The terminal of claim 11, wherein the RRC message further includes a second parameter indicating whether to apply a delay timer for the SR transmission.

13. The terminal of claim 12, wherein the at least one processor is further configured to:
in case that the regular BSR is triggered and that the second parameter indicates to apply the delay timer for the SR transmission, identify whether the first parameter indicates to delay the SR transmission.

14. The terminal of claim 11, wherein the at least one processor is further configured to:
in case that the timer used to determine whether to delay the SR transmission is running, delay the SR transmission.

15. The terminal of claim 14, wherein the at least one processor is further configured to:
in case that the timer used to determine whether to delay the SR transmission is running, start or restart a delay timer for the SR transmission,
wherein the SR transmission is delayed until the delay timer for the SR transmission expires.
